(19) United States
(12) Patent Application Publication
(10) Pub. No.: US 2009/0265626 A1
(43) Pub. Date: Oct. 22, 2009

(54) APPARATUS AND METHOD OF CONTROLLING DISPLAY

(75) Inventor: Tomoaki Suga, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/419,783

(22) Filed: Apr. 7, 2009

(30) Foreign Application Priority Data
Apr. 16, 2008 (JP) 2008-106803

(51) Int. Cl. G06F 17/00

(52) U.S. Cl. 715/274

(57) ABSTRACT

A print preview image of structured document data including link information is generated and displayed in a display unit, and location information indicating a position of a linked area in the print preview image is generated. The linked area corresponds to the link information included in the structured document data. If it is determined that a user specifies a linked area in the print preview image, linked data indicated by the link information corresponding to the linked area is acquired and the acquired linked data is displayed. This allows the user to refer to information about the linked data without clearing a print preview mode to switch the display mode to a browsing mode.

### BACKGROUND OF THE INVENTION

1. Field of the Invention

The present invention relates to a display control apparatus and a display control method for displaying a print preview. More particularly, the present invention relates to a display control apparatus and a display control method for displaying a print preview of target print data including link information.

2. Description of the Related Art

The amount of data described in structured document formats typified by Hypertext Markup Language (HTML) is rapidly increased along with prevalence of the Internet. This results in a tendency to increase the demand for print of data including link information indicating linked items. However, since the formats of the structured documents do not allow for the printing, the appearance in applications, such as browsers, is rarely reflected in the print layout. Accordingly, importance is attached to print preview functions allowing confirmation of the outputs before printing.

In such situations, many technologies involved in the print preview are disclosed in related art. For example, U.S. Patent Publication No. 2004/0207859 discloses a technology for displaying multiple print preview images that are shifted vertically and horizontally to be overlapped with each other. This technology allows users to easily visually recognize both the printing of the multiple copies and the content of the printing. Japanese Patent Laid-Open No. 2007-257069 discloses a technology for replacing the tag of a part, such as a banner link, which is selected by a user on a print preview display and which the user does not want to print with a placeholder to delete the part in printing.

When structured document data including link information is displayed in a print preview, the user can find a linked display item in which the user is interested in the displayed print preview. However, it is necessary for the user to clear the print preview display mode in order to browse the linked item in the related art.

For example, in the technology for displaying multiple print preview images, print data that is selected in advance as print candidates is displayed, so that it is not possible to further increase the number of the print preview images once the print preview is displayed. Accordingly, in order for the user to browse a linked item in the print preview images, it is necessary for the user to follow the link after clearing the print preview display mode to switch the display mode to a structured document browsing mode. In the technology for deleting, for example, a banner link in the printing, the browsing of a linked item in a print preview image is not considered although the print preview image can be edited.

### SUMMARY OF THE INVENTION

In order to resolve the above problems, the present invention provides a display control method capable of specifying a linked display item in an image to acquire linked data when a print preview image of target print data including link information is displayed.

According to an exemplary embodiment of the present invention, a display control method generating a print preview image of structured document data and displaying the generated print preview image in a display unit includes a first display controlling step of generating a print preview image of structured document data including link information on the basis of print setting information to display the generated print preview image in the display unit; a generating step of generating location information indicating a position of a linked area in the print preview image, the linked area corresponding to the link information included in the structured document data, on the basis of the structured document data and the print setting information; an acquiring step of acquiring linked data indicated by the link information corresponding to the linked area if it is determined that an instruction that is input specifies a linked area in the print preview image on the basis of the generated location information; and a second display controlling step of displaying the print preview image in the display unit on the basis of the acquired linked data.

According to another exemplary embodiment of the present invention, a display control apparatus generating a print preview image of structured document data and displaying the generated print preview image in a display unit includes a first display controlling unit configured to generate a print preview image of structured document data including link information on the basis of print setting information to display the generated print preview image in the display unit; a generating unit configured to generate location information indicating a position of a linked area in the print preview image, the linked area corresponding to the link information included in the structured document data, on the basis of the structured document data and the print setting information; an acquiring unit configured to acquire linked data indicated by the link information corresponding to the linked area if it is determined that an instruction that is input specifies a linked area in the print preview image on the basis of the generated location information; and a second display controlling unit configured to display the print preview image in the display unit on the basis of the acquired linked data.

Further features of the present invention will become apparent from the following description of exemplary embodiments with reference to the attached drawings.

### BRIEF DESCRIPTION OF THE DRAWINGS

FIG. 1 illustrates an example of a print system according to an exemplary embodiment of the present invention.

FIG. 2 is a block diagram showing an example of the configuration of a PC according to an exemplary embodiment of the present invention.

FIG. 3 is a block diagram showing an example of the functional configuration of a print module.

FIG. 4 is a flowchart showing an example of a process of displaying a print preview image in a display unit, according to an exemplary embodiment of the present invention.

FIGS. 5A and 5B show examples of print preview images.

FIG. 6 is a flowchart showing an example of a process of displaying a print preview image when print settings are changed during the display of the print preview, according to an exemplary embodiment of the present invention.

FIG. 7 is a flowchart showing an example of a display process when a cursor is displayed in the print preview image, according to an exemplary embodiment of the present invention.

FIG. 8 illustrates how the display of the cursor is changed in the print preview image.

FIG. 9 illustrates how a linked display item is changed in the print preview image.

FIG. 10 is a flowchart showing an example of a process when a linked display item is specified during the display of the print preview, according to an exemplary embodiment of the present invention.

FIG. 11 illustrates an example of a display method when multiple print preview images exist.

FIG. 12 is a flowchart showing an example of a process when a user directly inputs a URL, according to an exemplary embodiment of the present invention.

FIGS. 13A and 13B show examples of input screens in which the user directly input a URL.

FIG. 14 is a flowchart showing an example of a process of switching the print preview image, according to an exemplary embodiment of the present invention.

FIGS. 15A and 15B show an example of the switch of the display of the print preview image.

FIG. 16 shows examples of display of screens when the settings are made for each target print data.

### DESCRIPTION OF THE EMBODIMENTS

Exemplary embodiments of the present invention will herein be described in detail with reference to the attached drawings.

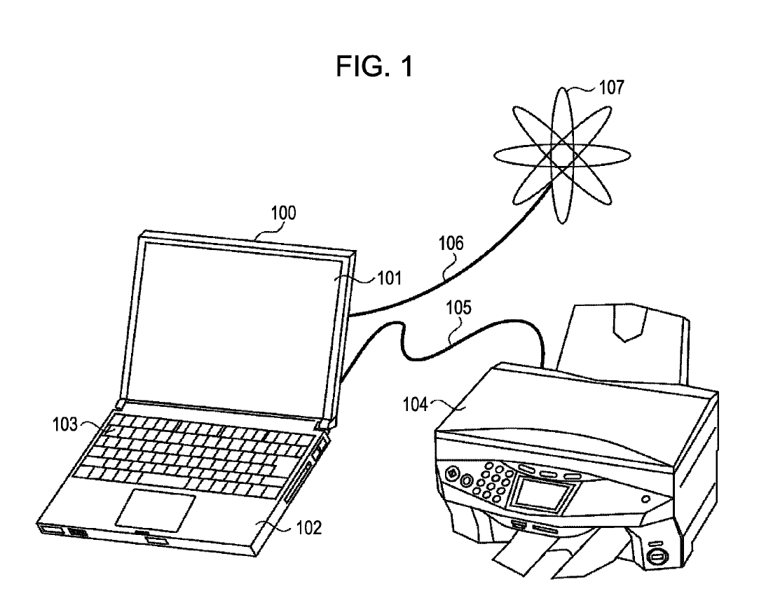

FIG. 1 illustrates an example of a print system according to an exemplary embodiment of the present invention. The print system includes a personal computer (PC) 100 and a printer 104. The PC 100 has a printer driver installed therein and serves as a display control apparatus causing a print preview image to be displayed. The PC 100 is connected to the printer 104 via, for example, a universal serial bus (USB) cable 105. The PC 100 is connected to the Internet 107 via a local area network (LAN) cable 106 and a router (not shown).

Referring to FIG. 1, the PC 100 is a so-called notebook-sized PC and includes a display unit 101, an information processing unit 102, and an input device 103. However, the present invention is not restricted to such a configuration. The PC 100 may be a so-called desktop PC in which the display unit 101 and the input device 103 are separated from the information processing unit 102 and the standalone information processing unit 102 operates as a display control apparatus.

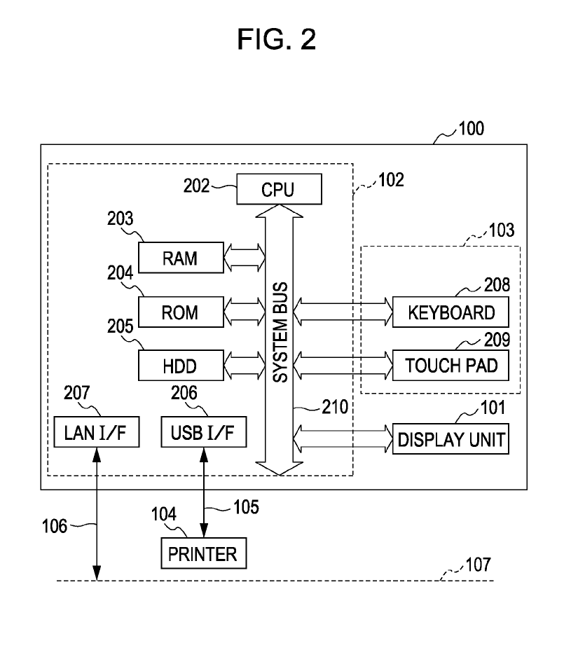

FIG. 2 is a block diagram showing an example of the configuration of the PC 100 according to an exemplary embodiment of the present invention. Referring to FIG. 2, the PC 100 includes a central processing unit (CPU) 202 in the information processing unit 102. The CPU 202 performs arithmetic operation, determination, etc. in accordance with instructions to process data and control devices. Storage units including a random access memory (RAM) 203, a read only memory (ROM) 204, and a hard disk drive (HDD) 205 in the information processing unit 102 stores the operating system (OS), a printer driver, and other control programs. A USB interface 206 in the information processing unit 102 is a device that performs data communication with the printer 104 via the USB cable 105. A LAN interface 207 in the information processing unit 102 is a device connected to the LAN cable 106 and is connected to the Internet 107 via, for example, the router (not shown). The input device 103 includes a keyboard 208 used by a user to input characters and numerals and a touch pad 209 serving as a pointing device. For example, a mouse may be used as the pointing device, instead of the touch pad 209. The above devices are connected to each other via a system bus 210.

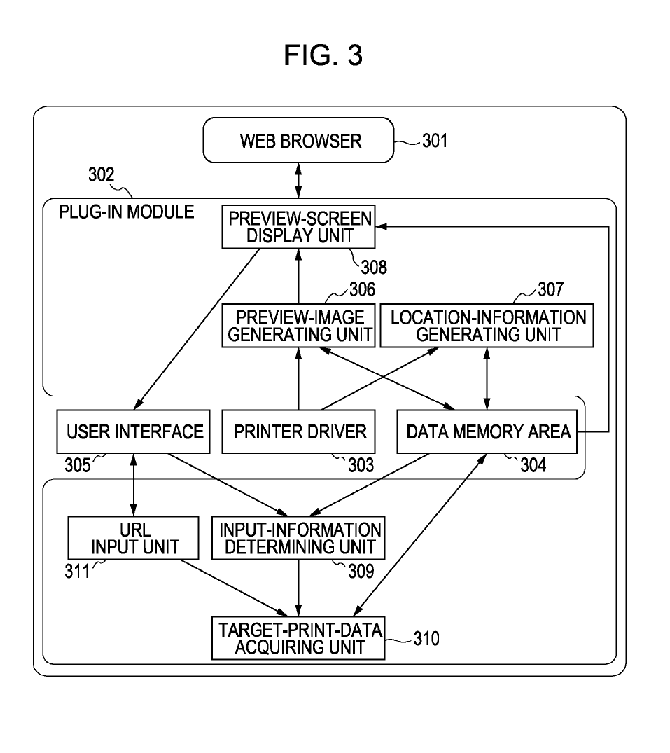

FIG. 3 is a block diagram showing an example of the functional configuration of a print module executed by the information processing unit 102 in the PC 100. Referring to FIG. 3, a Web browser 301 is software used by the user to browse and edit a structured document, such as a Web page, which is downloaded and acquired from the Internet 107. The Web browser 301 requests for display of a print preview of a Web page. A plug-in module 302 has a function of causing the display unit 101 to display a print preview of a Web page via the OS and a display driver in response to the request from the Web browser 301. The plug-in module 302 is independent of a printer driver 303 and is normally stored in, for example, the HDD 205. The plug-in module 302 is loaded in the RAM 203 by the CPU 202 to be executed in response to a call from the Web browser 301. However, the display process of a print preview is not restrictedly performed by the independent plug-in module 302. For example, a module read out and instructed from the printer driver 303, that is, a module existing in the printer driver 303 may perform the display process of a print preview of print data.

The printer driver 303 is a program executed by the CPU 202 and is specific to the printer 104 in order to allow optimal settings and control in accordance with, for example, the functions of the printer 104. The printer driver 303 includes print setting items including sheet sizes, sheet types, layouts, and the number of copies, which can be set for the printer 104. The values of the items that have been set are stored in, for example, the HDD 205 and are used in the printing. The user can change the print settings with a print setting screen displayed in the display unit 101. A print preview image is generated on the basis of the print settings set by the user.

A data memory area 304 is built in the RAM 203 or the HDD 205 and stores structured documents, such as Web data, downloaded from the Internet. Information necessary to execute the processing in the plug-in module 302 is also temporarily stored in the data memory area 304. A user interface 305 is a module that causes the display unit 101 to display a print preview image and that receives a user's operation with the input device 103 as an instruction from the user. The user issues the instruction by operating the cursor in the print preview image with, for example, the touch pad 209.

The blocks in the plug-in module 302 will now be described. All the blocks named “units” in the plug-in module 302 are software modules that are realized by the processing by the CPU 202. In the plug-in module 302, a preview-image generating unit 306 acquires a structured document, such as Web data, to be printed from the data memory area 304 and acquires print setting information from the printer driver 303. The preview-image generating unit 306 analyzes the acquired information to generate a print preview image.

A location-information generating unit 307 analyzes the structured document, such as Web data, to be printed and generates location information indicating the part where a linked item is displayed in the print preview image on the basis of the result of the analysis and the print setting information acquired from the printer driver 303. The location information is generated as, for example, coordinate information in the print preview image and is stored in the storage area of the data memory area 304 along with the URL included in link information. The location information is stored, for example, in a table format in association with the URL corresponding to the location information.

A preview-screen display unit 308 is a display control module that displays a print preview image in the display unit 101. Specifically, the preview-screen display unit 308 lays out the print preview image generated by the preview-image generating unit 306 at a predetermined position to display a print preview screen in the display unit 101. An input-information determining unit 309 determines whether an instruction from the user, received through the user interface 305, is an action specifying a link existing in the print preview image. Specifically, the input-information determining unit 309 compares positional information about the position in the print preview image specified on the basis of the instruction from the user with the location information stored by the location-information generating unit 307.

If the print settings are changed on the print preview screen, the position where the print preview image is displayed may be shifted to move the print preview screen on the display screen. However, it is known that the position where the print preview image is displayed and the position of the print preview screen on the display screen can be detected from the content of the print settings. Accordingly, the input-information determining unit 309 can appropriately perform the comparison even if the position where the print preview image is displayed is shifted.

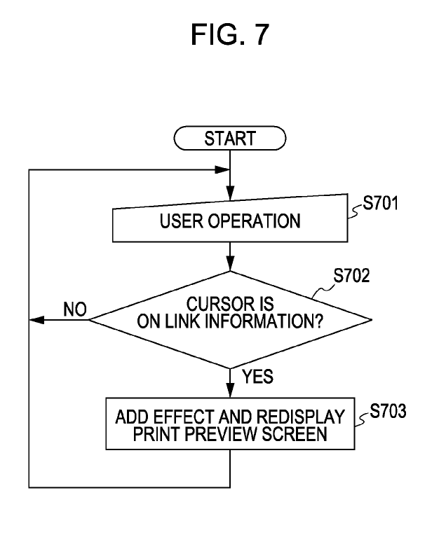

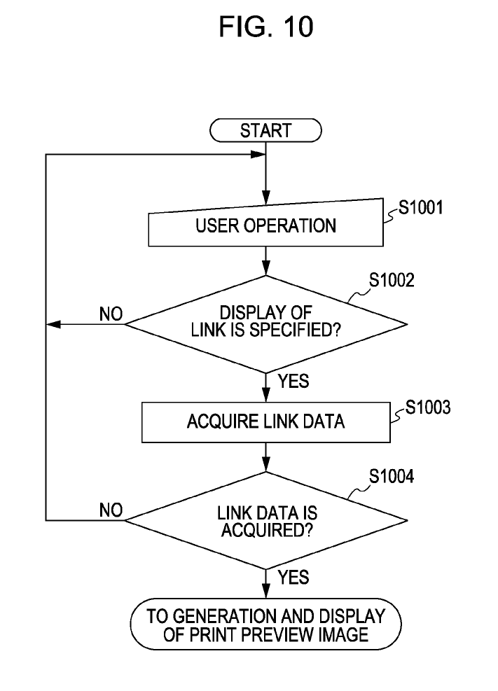

Since the print preview image is normally bitmap data, it is not possible to determine where the linked item is displayed in the image from the bitmap data. However, the generation of the location information and the comparison of the location information with the positional information specified in the print preview image allow the determination of whether the user specifies a linked display item. This will be described in detail below with reference to FIG. 7 and FIG. 10.

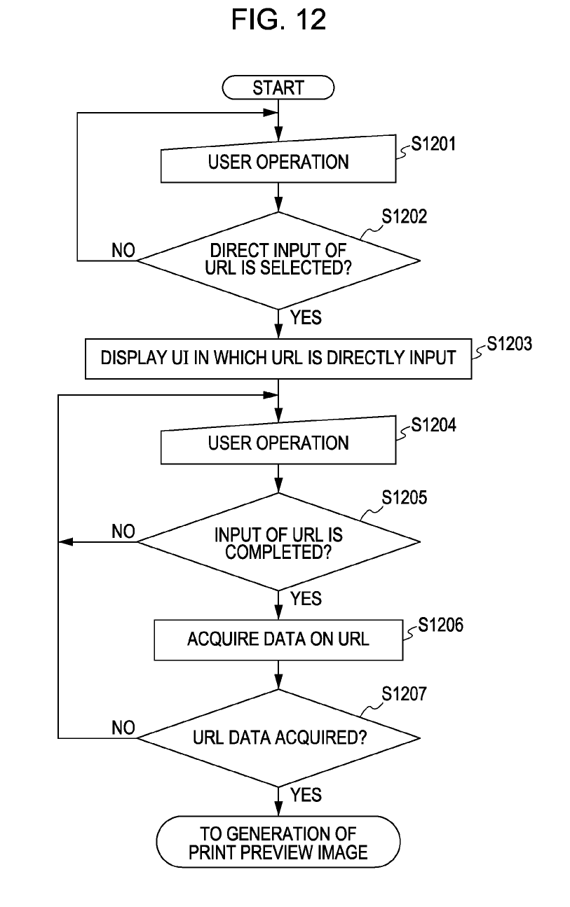

A target-print-data acquiring unit 310 reads out the URL corresponding to a linked display item stored in the data memory area 304 if the input-information determining unit 309 determines that the user specifies the linked display item. Then, the target-print-data acquiring unit 310 acquires linked data specified by the readout URL and stores the acquired linked data in the data memory area 304. A URL input unit 311 is a module that causes the display unit 101 to display a URL input dialogue via the user interface 305. The user can operate the keyboard 208 to input a URL in the URL input dialogue. The target-print-data acquiring unit 310 uses the input URL to acquire the linked data and stores the acquired data in the data memory area 304. This will be described in detail below with reference to FIG. 12.

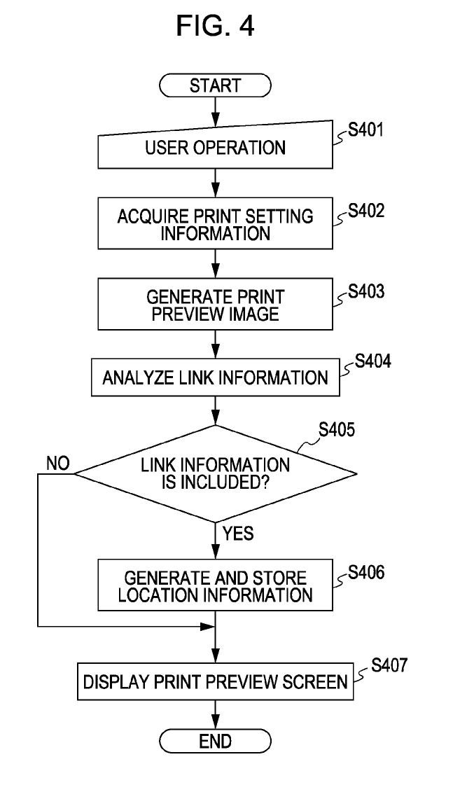

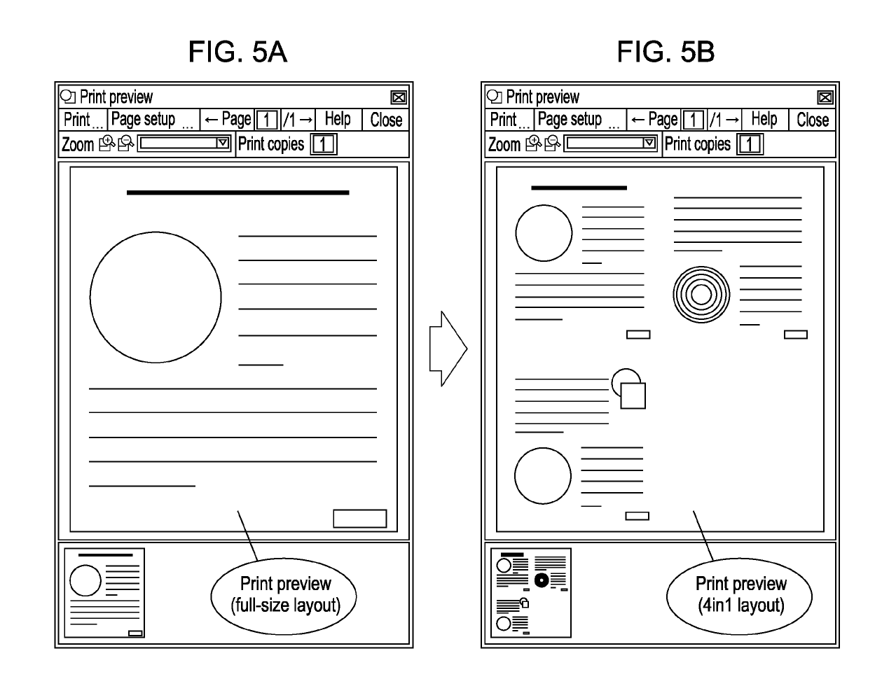

FIG. 4 is a flowchart showing an example of a process of displaying a print preview image in the display unit 101, according to an exemplary embodiment of the present invention. Referring to FIG. 4, in Step S401, the plug-in module 302 waits for a request for display of a print preview from the Web browser 301 in response to an instruction from the user with the input device 103. In Step S402, the preview-image generating unit 306 acquires print setting information from the printer driver 303. In Step S403, the preview-image generating unit 306 reads out data about a structured document, such as a Web page, to be printed from the data memory area 304 to generate a print preview image. The print preview image is generated in accordance with the print settings acquired in Step S402. FIGS. 5A and 5B show examples of print preview images. A print preview image in FIG. 5A is displayed if a full-size layout is selected while a print preview image in FIG. 5B is displayed if a four-divided layout (4in1 layout) is selected. If multiple pages are to be printed, the print preview images for all the pages are generated. Image data about the print preview image(s) generated in the above manner is temporarily stored in the data memory area 304.

In Step S404, the location-information generating unit 307 reads out the data about the structured document, such as a Web page, to be printed from the data memory area 304 to analyze the presence of link information. In Step S405, the location-information generating unit 307 determines whether the link information is included in the structured document data on the basis of the result of the analysis in Step S404. If the location-information generating unit 307 determines that the link information is included in the structured document data (YES in Step S405), the process goes to Step S406. If the location-information generating unit 307 determines that no link information is included in the structured document data (NO in Step S405), the process goes to Step S407. In Step S406, the location-information generating unit 307 analyzes the data about the structured document, such as a Web page, to be printed. In addition, the location-information generating unit 307 acquires the print setting information from the printer driver 303 and estimates the position where the linked display item is laid out in the print preview image to generate location information. If the print preview is across multiple pages, this operation is performed for all the pages. The location information generated in the above manner is temporarily stored in the data memory area 304 along with the URL.

In Step S407, the preview-screen display unit 308 reads out the print preview image generated in Step S403 from the data memory area 304 and displays the readout print preview image in the display unit 101 as first display control. The print preview image is laid out at a predetermined position to compose the print preview screen that is displayed via the user interface 305. For example, in each of the examples in FIGS. 5A and 5B, the print preview image is laid out both in an area where the print preview image is displayed in a normal size and in an area where the print preview image is displayed in a reduced size.

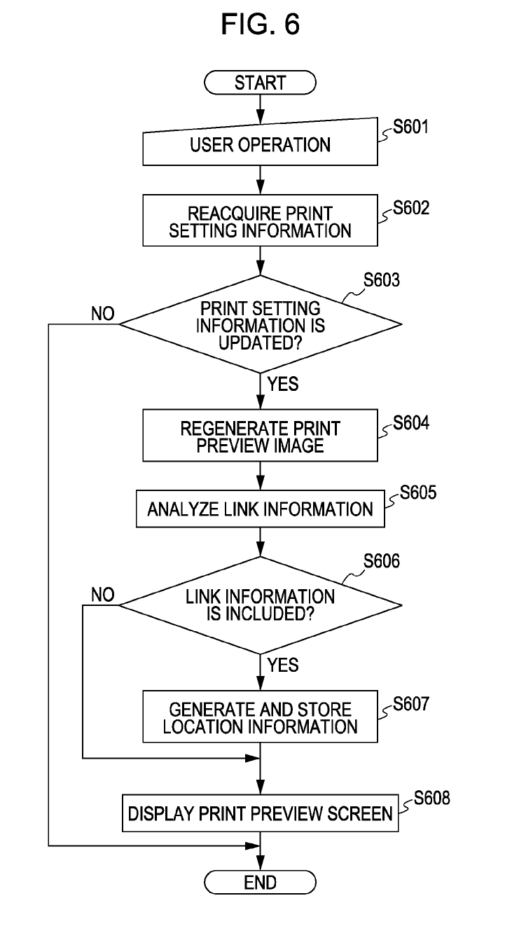

FIG. 6 is a flowchart showing an example of a process of displaying a print preview image when the print settings are changed during the display of the print preview, according to an exemplary embodiment of the present invention. Referring to FIG. 6, in Step S601, the user inputs an instruction with the input device 103 and the plug-in module 302 requests for change of the print settings in response to the instruction from the user with the input device 103. In Step S602, the preview-image generating unit 306 acquires the current print setting information from the printer driver 303. In Step S603, the preview-image generating unit 306 determines whether the print setting information acquired in Step S602 differs from the print setting information before the user's operation. If the preview-image generating unit 306 determines that the print setting information acquired in Step S602 differs from the print setting information before the user's operation (YES in Step S603), the process goes to Step S604. If the preview-image generating unit 306 determines that the print setting information acquired in Step S602 does not differ from the print setting information before the user's operation (NO in Step S603), the process in FIG. 6 is terminated. In Step S604, the preview-image generating unit 306 reads out the data about the structured document, such as a Web page, to be printed from the data memory area 304 again to regenerate a print preview image corresponding to the updated print settings. If the print preview is across multiple pages, the print preview images for all the pages are generated. The image data about the print preview image(s) regenerated in the above manner is temporarily stored in the data memory area 304 and the print preview image generated in accordance with the old print setting information is deleted.

Steps S605 to S608 are similar to Steps S404 to S407 in FIG. 4, in which a print preview screen including the print preview image regenerated in Step S604 is displayed in the display unit 101.

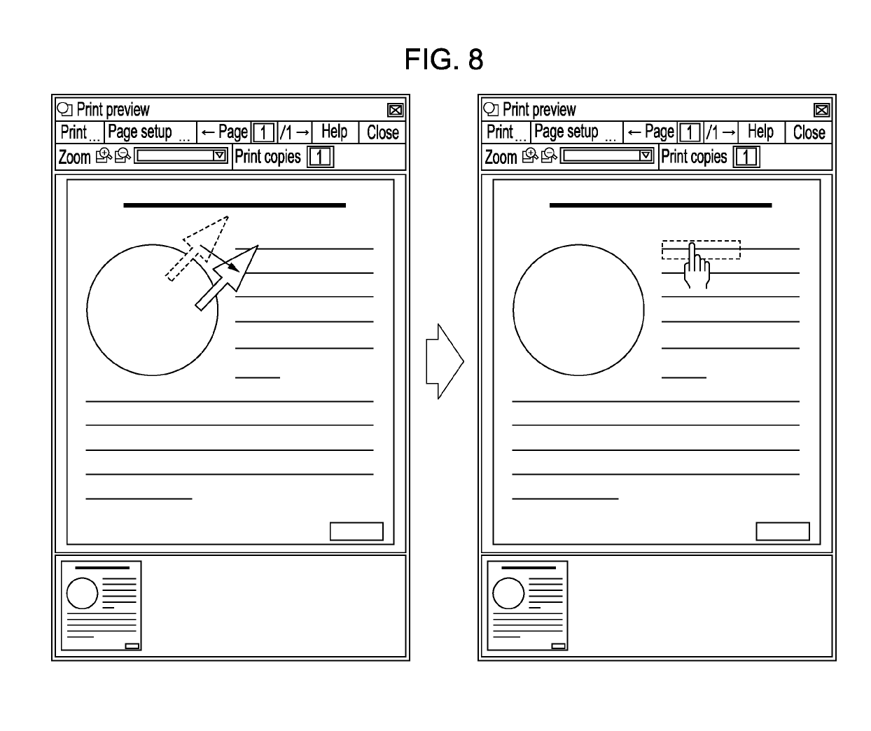

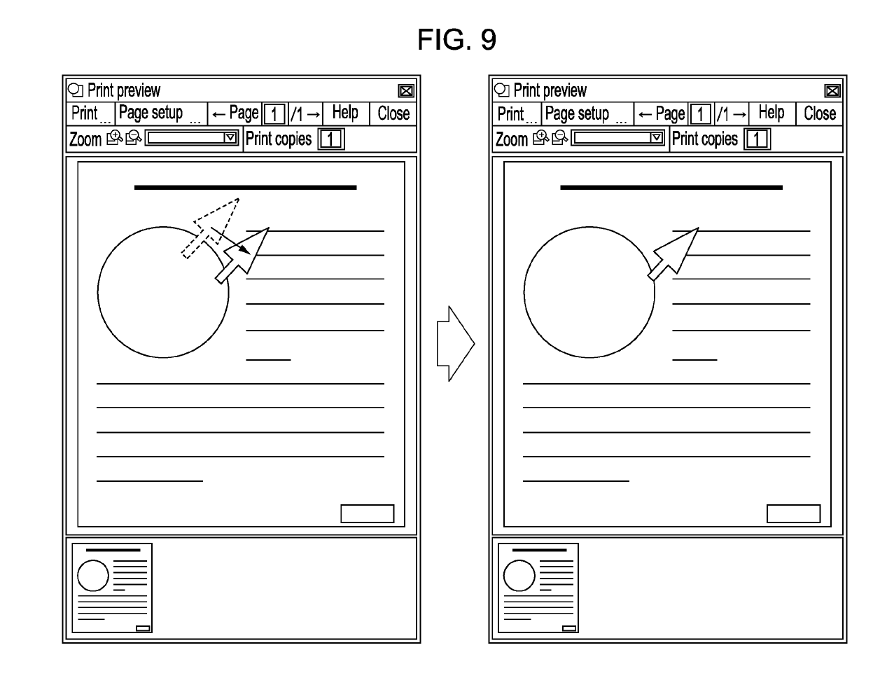

FIG. 7 is a flowchart showing an example of a display process when the cursor is displayed in the print preview image displayed in accordance with the process shown in FIG. 4 or 6, according to an exemplary embodiment of the present invention. Referring to FIG. 7, in Step S701, the process waits for a user's operation with the input device 103 to move the displayed cursor. For example, the user drags the cursor with the touch pad 209 to move the cursor. In Step S702, the input-information determining unit 309 compares the location information stored in the data memory area 304 with the positional information about the cursor displayed in the print preview image. The input-information determining unit 309 determines whether the cursor is on a linked display item in the print preview image on the basis of the result of the comparison. If the input-information determining unit 309 determines that the cursor is on a linked display item (YES in Step S702), the process goes to Step S703. If the input-information determining unit 309 determines that the cursor is not on a linked display item (NO in Step S702), the process goes back to Step S701. In Step S703, the preview-screen display unit 308 adds an effect indicating to the user that the cursor is on the linked display item in the print preview image and redisplays the print preview screen in the display unit 101. The effect is, for example, change of the shape of the cursor displayed in the print preview image shown in FIG. 8 or change of the linked display item on which the cursor exists shown in FIG. 9. The effect allows the user to know the presence of the linked display item in the print preview image and the position of the linked display time in the print preview image.

FIG. 10 is a flowchart showing an example of a process when a linked display item is specified during the embodiment of the present invention. Referring to FIG. 10, in Step S1001, the process waits for a user's operation with the input device 103 to move the displayed cursor in the print preview image and specify an arbitrary position. For example, the user performs a click operation on the touch pad 209 to specify the position where the cursor is displayed. In Step S1002, the input-information determining unit 309 compares the location information about the linked display item stored in the data memory area 304 with the positional information specified in Step S1001. The input-information determining unit 309 determines whether the user specifies the linked display item on the basis of the result of the comparison. If the input-information determining unit 309 determines that the user specifies the linked display item (YES in Step S1002), the process goes to Step S1003. If the input-information determining unit 309 determines that the user does not specify the linked display item (NO in Step S1002), the process goes back to Step S1001. The user can easily specify the linked display item by following the process shown in FIG. 7 because the print preview image is displayed in the manner shown in FIG. 8 or FIG. 9 if the cursor that has moved in the print preview image in Step S1001 is on the linked display item. Although the location information is compared with the specified positional information after the user's click operation in the above description, another method may be adopted by following the process in FIG. 7. Specifically, the display of the print preview image is changed on the basis of the location information according to the process in FIG. 7 if the cursor is on the linked displayed item. Accordingly, it can be determined that the linked display item is specified without the above comparison if the user performs the click operation in the state where the display of the print preview image is changed.

In Step S1003, the target-print-data acquiring unit 310 acquires linked data indicated by the position specified in Step S1001 on the basis of the URL stored in the data memory area 304. The acquired data is stored in the data memory area 304. The linked data may be acquired by using the acquiring function of the plug-in module 302 or may be acquired via the Web browser 301. In Step S1004, it is determined whether the linked data has been acquired in Step S1003. If it is determined that the linked data has been acquired (YES in Step S1004), the print preview image of the linked data is generated and the generated print preview image is displayed in the display unit 101 as second display control. The print preview image is displayed in the same manner as in FIG. 4. If it is determined in Step S1004 that the linked data has not been acquired due to, for example, the broken link (NO in Step S1004), the process goes back to Step S1001. It is possible that the web page of the linked data acquired in Step S1003 is displayed in the display unit 101 as second display control.

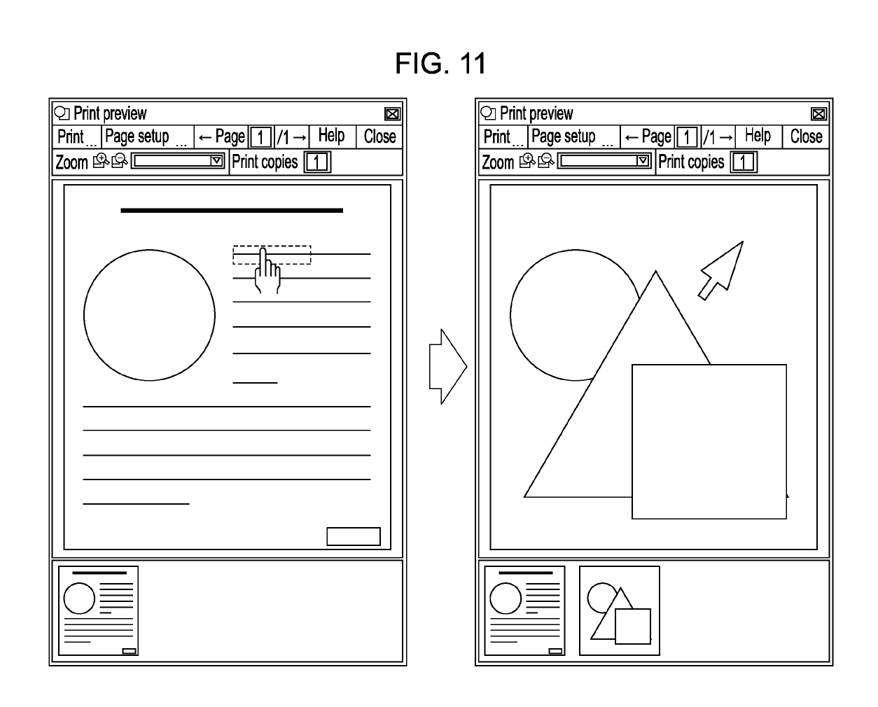

A print preview image of linked data can be generated from another print preview image in accordance with the above process. An example of a display method when multiple print preview images exist is shown in FIG. 11.

Referring to FIG. 11, the print preview image of linked target print data is displayed in an enlarged display area and the reduced print preview images of all the target print data are displayed in a reduced display area. Although the print preview image of the linked data acquired in Step S1003 is generated in the above description, the present invention is not restricted to the generation of the print preview image of the linked data acquired in Step S1003 and the Web browser 301 may be used to display the linked Web page. Also in this case, it is possible for the user to browse the linked Web page without clearing the print preview display mode.

In addition, the location information is generated from the result of the analysis of the structured document data and the print setting information to determine whether the position in the print preview image, specified by the user, indicates a linked display item in the above description. However, the present invention is not restricted to this and it is sufficient to determine whether a linked display item is specified by the user on the basis of the structured document data and the print setting information.

A case where the user directly inputs an URL while the print preview screen is displayed will now be described. FIG. 12 is a flowchart showing an example of a process when the user directly inputs a URL, according to an exemplary embodiment of the present invention. Referring to FIG. 12, in Step S1201, the process waits for a user's operation with the input device 103 to select direct input of a URL on the print preview screen. In Step S1202, the input-information determining unit 309 determines whether the user's operation in Step S1201 selects the direct input of a URL. If the input-information determining unit 309 determines that the user's operation in Step S1201 selects the direct input of a URL (YES in Step S1202), the process goes to Step S1203. If the input-information determining unit 309 determines that the user's operation in Step S1201 does not select the direct input of a URL (NO in Step S1202), the process goes back to Step S1201.

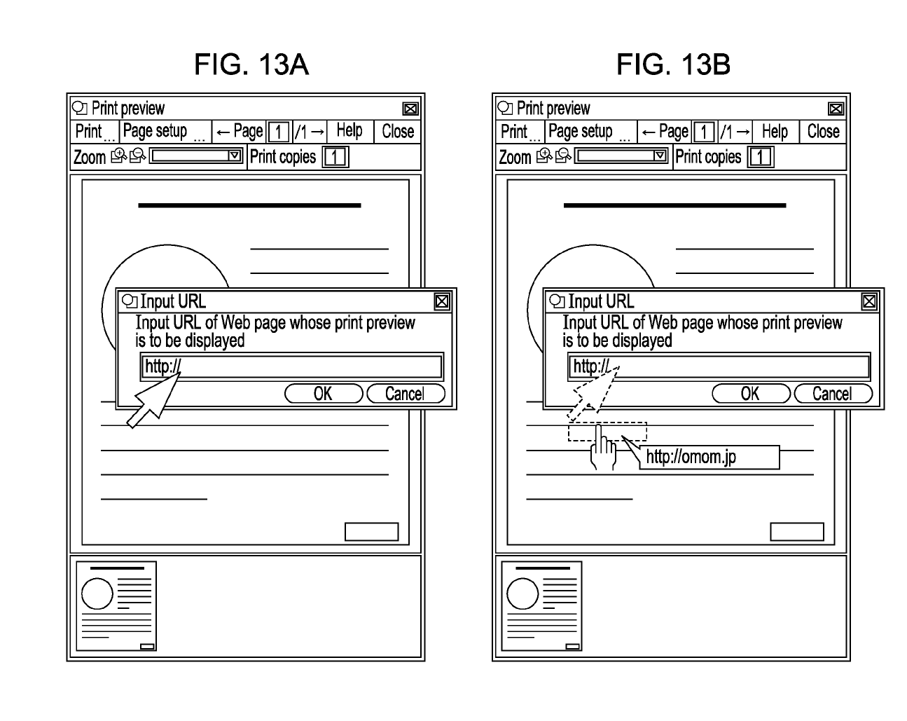

In Step S1203, the URL input unit 311 displays an input screen where the user can directly input an URL. FIGS. 13A and 13B show examples of input screens in which the user directly input a URL. For example, a URL input dialogue shown in FIG. 13A is displayed in Step S1203. In Step S1204, the process waits for completion of a user's operation with the input device 103 to input a URL in the URL input dialogue. For example, the user operates the keyboard 208 to directly input a URL. In this case, the URL is displayed in response to the user's input operation and the displayed URL is determined in response to an instruction to complete the input. If it is difficult to directly input a URL, a URL may be displayed when the cursor is on the linked display item, as shown in FIG. 13B. In Step S1205, the input-information determining unit 309 determines whether the user issues the instruction to complete the input of the URL. If the input-information determining unit 309 determines that the user issues the instruction to complete the input of the URL (YES in Step S1205), information about the input URL is acquired by the URL input unit 311 and the acquired information is stored in the data memory area 304. Then, the process goes to Step S1206. If the input-information determining unit 309 determines that the input of the URL is not completed (NO in Step S1205), the process goes back to Step S1204. In Step S1206, the target-print-data acquiring unit 310 acquires data on the URL input in Step S1204 and stores the acquired data in the data memory area 304. In Step S1207, the target-print-data acquiring unit 310 determines whether the data has been acquired in Step S1206. If the target-print-data acquiring unit 310 determines that the data has been acquired in Step S1206 (YES in Step S1207), the print preview image of the Web page specified by the URL is generated in accordance with the acquired data and the generated print preview image is displayed in the display unit 101. The display is performed in the same manner as in FIG. 4. If the target-print-data acquiring unit 310 determines in Step S1207 that the data has not been acquired in Step S1206 (NO in Step S1207), the process goes back to Step S1204.

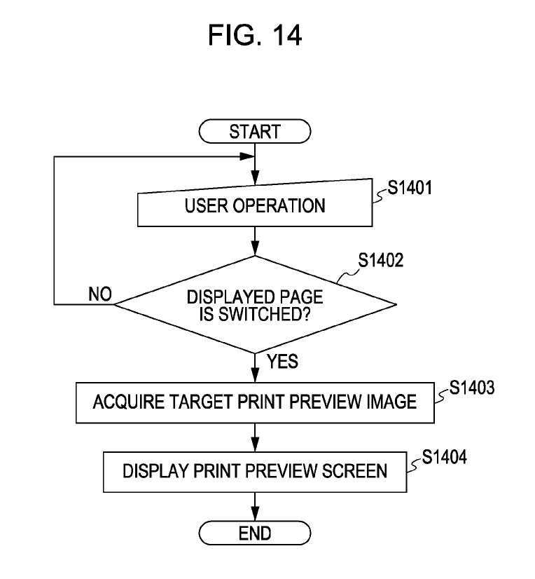

A display method when multiple print preview images are generated in the above exemplary embodiments will now be described. FIG. 14 is a flowchart showing an example of a process of switching the print preview image, according to an exemplary embodiment of the present invention. Referring to FIG. 14, in Step S1401, the user operates the input device 103 to input an instruction. In Step S1402, the input-information determining unit 309 determines whether the user instructs to switch the display of the print preview image in Step S1401. If the input-information determining unit 309 determines that the user instructs to switch the display of the print preview image in Step S1401 (YES in Step S1402), the process goes to Step S1403. If the input-information determining unit 309 determines that the user does not instruct to switch the display of the print preview image in Step S1401 (NO in Step S1402), the process goes back to Step S1401. In Step S1403, the preview-screen display unit 308 reads out the print preview image corresponding to the instruction from the user in Step S1401 from the data memory area 304. In Step S1404, the print preview screen on which the readout print preview image is laid out at a predetermined position is redisplayed in the display unit 101 via the user interface 305. This switches the displayed print preview image.

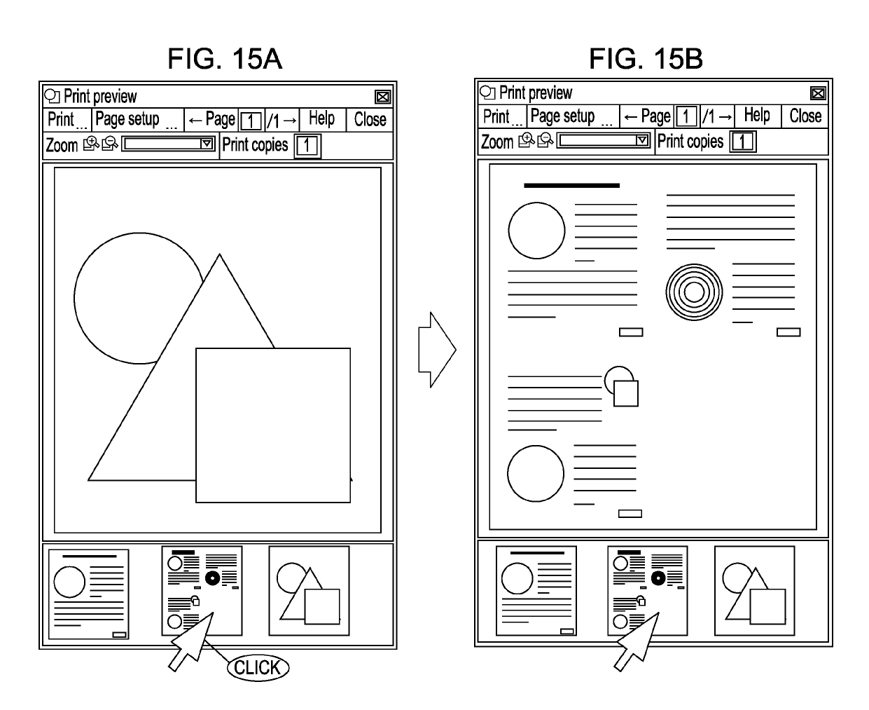

FIGS. 15A and 15B show an example of the switch of the display of the print preview image according to the process in FIG. 14. First, the user operates the cursor on the print preview screen with the input device 103 to select a print preview image that is reduced in size by clicking, as shown in FIG. 15A. Then, the selected print preview image is enlarged as the print preview image that is currently selected by the user and the display of the print preview image is switched, as shown in FIG. 15B.

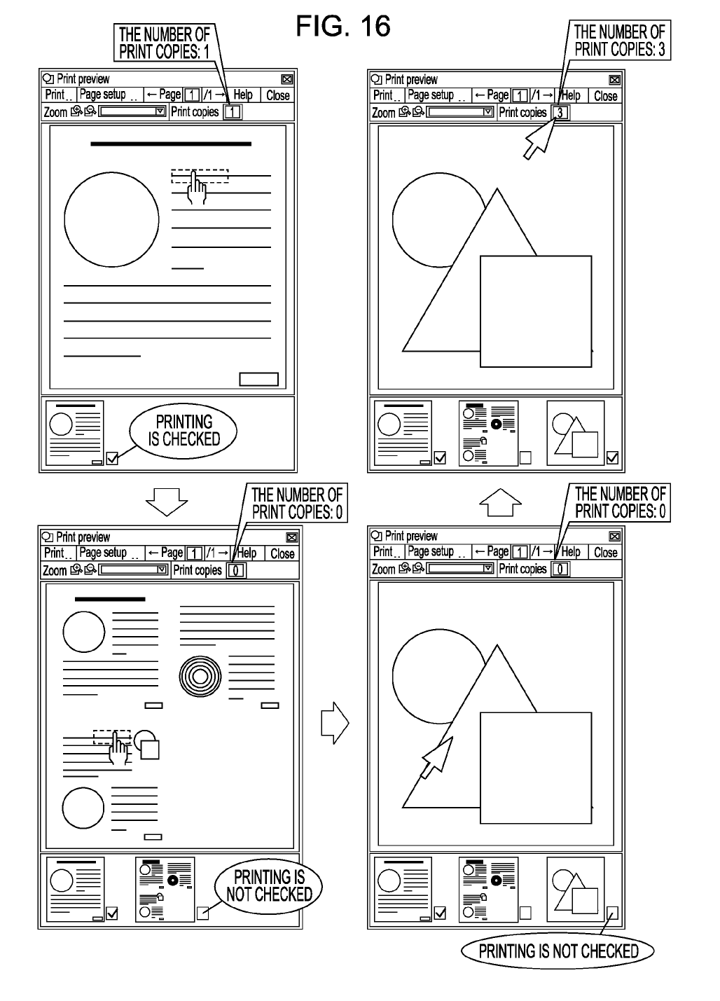

Since a print preview image of linked data can be generated from another print preview image according to the above process, the repetition of the above process generates multiple print preview images. However, the image which the user does not want to print can be undesirably included in the print preview images depending on the content of the linked data. In order to prevent unnecessary pages from being printed, the necessity of the printing and the number of print copies may be set for each target print data. FIG. 16 shows examples of display of screens when the settings are made for each target print data.

The number of print copies can be set for each of the multiple print preview images in FIG. 16. In addition, a check box used for specifying whether the printing is performed is displayed for each of the print preview images that are reduced in size. The print preview image that is selected can be enlarged (FIGS. 15A and 15B). Accordingly, the user selects a print preview image from the print preview images that are reduced in size to enlarge the selected print preview image and confirms the content of the print preview image. Then, the user clicks the check box to display a check mark shown in FIG. 16 and sets the number of print copies. This allows the user to easily select the image which the user wants to print from the multiple print preview images and to easily instruct the number of print copies. The check mark indicating that the printing is performed may not be displayed in the check box when the number of print copies is not set while the check mark may be automatically displayed in the check box to print the corresponding page when the number of print copies is set.

As described above, according to the exemplary embodiments of the present invention, it is possible to specify linked data in a print preview image and to display the specified linked data in another print preview image. Although the target print data is data about the structure document, such as a Web page, in the above exemplary embodiments, any data that includes link information is applicable to the present invention.

The present invention can be embodied by supplying a computer-readable storage medium storing program code realizing the functions according to the above exemplary embodiments to a system or an apparatus, the computer (or CPU or micro processing unit (MPU)) in which system or apparatus executes the program code stored on the computer-readable storage medium. In this case, the program code read out from the computer-readable storage medium realizes the functions according to the above exemplary embodiments. The present invention is applicable to the computer-readable storage medium storing the program code and the program code itself. The computer-readable storage medium supplying the program code may be, for example, a hard disk, a compact disk-read only memory (CD-ROM), a compact disk-recordable (CD-R), a nonvolatile memory card, a ROM, or a digital versatile disk (DVD). In addition, the OS or the like running on the computer may execute all or part of the actual processing based on instructions in the program code to realize the functions of the exemplary embodiments described above. Alternatively, after the program code realizing the functions of the above exemplary embodiments is written in a memory that is provided in a function expansion board included in the computer or in a function expansion unit connected to the computer, the CPU or the like in the function expansion board or the function expansion unit may execute all or part of the actual processing based on instructions in the program code to realize the functions of the exemplary embodiments described above.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-106803 filed Apr. 16, 2008, which is hereby incorporated by reference herein in its entirety.

What is claimed is:

1. A display control method generating a print preview image of structured document data and displaying the generated print preview image in a display unit, the method comprising:
a first display controlling step of generating a print preview image of structured document data including link information on the basis of print setting information and displaying the generated print preview image in the display unit;
a generating step of generating location information indicating a position of a linked area in the print preview image, the linked area corresponding to the link information included in the structured document data, on the basis of the structured document data and the print setting information;
an acquiring step of acquiring linked data indicated by the link information corresponding to the linked area if it is determined that an instruction that is input specifies a linked area in the print preview image on the basis of the generated location information; and
a second display controlling step of displaying an image in the display unit on the basis of the acquired linked data.

2. The display control method according to claim 1, further comprising:
a movement controlling step of displaying a cursor in the print preview image displayed in the first display controlling step and moving the cursor in the print preview image in accordance with an instruction that is input,
wherein the display of the cursor or the display of the linked area is changed if it is determined that the cursor moved in the movement controlling step is in the linked area on the basis of the location information.

3. The display control method according to claim 1,
wherein, if the print setting information is updated after the print preview image is displayed in the first display controlling step, a print preview image is regenerated on the basis of the updated print setting information to be displayed and location information is generated on the basis of the updated print setting information.

4. The display control method according to claim 1,
wherein the print preview image of the linked data is displayed in the second display controlling step.

5. The display control method according to claim 4,
wherein the print preview image of the linked data is displayed, along with the print preview image displayed in the first display controlling step, in the second display controlling step.

6. The display control method according to claim 5, further comprising:
a selecting step of selecting the print preview image displayed in the first display controlling step or in the second display controlling step in response to an instruction that is input by a user,
wherein the selected print preview image is displayed in a size larger than that of the print preview image that is not selected.

7. The display control method according to claim 6,
wherein an item indicating whether the printing is performed is displayed for the print preview image that is not selected in the selecting step.

8. The display control method according to claim 7,
wherein the print preview image that is not selected in the selecting step is set as a print target in response to an instruction that is input by the user.

9. A computer-readable storage medium storing a program executing the display control method according to claim 1.

10. A display control apparatus generating a print preview image of structured document data and displaying the generated print preview image in a display unit, the apparatus comprising:
a first display controlling unit configured to generate a print preview image of structured document data including link information on the basis of print setting information and display the generated print preview image in the display unit;
a generating unit configured to generate location information indicating a position of a linked area in the print preview image, the linked area corresponding to the link information included in the structured document data, on the basis of the structured document data and the print setting information;
an acquiring unit configured to acquire linked data indicated by the link information corresponding to the linked area if it is determined that an instruction that is input specifies a linked area in the print preview image on the basis of the generated location information; and
a second display controlling unit configured to display an image in the display unit on the basis of the acquired linked data.
